(19) United States
(12) Patent Application Publication
(10) Pub. No.: US 2009/0235694 A1
(43) Pub. Date: Sep. 24, 2009

(54) GLASS MELTING APPARATUS

(75) Inventors: Sunao MIYAZAKI, Chiyoda-ku (JP); Shiro Funatsu, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Chiyoda-ku (JP)

(21) Appl. No.: 12/474,385

(22) Filed: May 29, 2009

Related U.S. Application Data
(63) Continuation of application No. PCT/JP07/73244, filed on Nov. 30, 2007.

(30) Foreign Application Priority Data
Nov. 30, 2006 (JP) 2006-323420

(51) Int. Cl. C03B 5/225

(52) U.S. Cl. 65/346

(57) ABSTRACT

A glass melting apparatus is provided with a clarifier tank adapted to clarify melted glass which is obtained by melting a raw glass material. Partition walls are provided in the clarifier tank so as to define a meandering flow passage through which the melted glass flows. A bottom of the clarifier tank is sloped so that the flow passage ascends from an upstream side thereof to a downstream side thereof.

### TECHNICAL FIELD

The present invention relates to a glass melting apparatus adapted for a small amount production of melted glass which is used for manufacturing optical elements or the like, and more particularly to a glass melting apparatus capable of supplying high-pure optical glass which is used when high-precise optical elements such as aspheric lenses are press-molded.

### BACKGROUND ART

Glass is obtained by heating raw materials that contain glass constituents such as SiO₂ in a melting furnace, and a conventional glass meting furnace has been limited to a large tank type melting furnace for continuously processing a large amount of glass by several ten tons per day.

Recently, in manufacturing optical glass elements such as lenses, there has been widely used a precise press-molding method capable of using press-molded glass as it stands without polishing a molded surface of the glass, and a small glass mass, which is so called as a fine gob (hereinafter, referred to as FG), manufactured from melted glass without post treatment has been used as a material to be press-molded to be an optical element.

Meanwhile, according to decrease in size of lenses or expansion in use of camera lenses incorporated in cellar phones or the like, an amount of glass used in a single lens has rapidly decreased. For this reason, when glass is produced in a furnace for several ten tons per day as in the past, stocks thereof increase and thus there is no advantage of mass production. From this background, in order to reduce the production of glass up to several ten kilos per day, small tank type glass melting furnaces are proposed as described in Japanese Patent No. 3332493 (Patent Document 1) or Japanese Patent Publication No. 2000-128548A (Patent Document 2). In the glass melting furnace described in Patent Document 1, the inside of the furnace is divided by partition plates to regulate flowing of melted glass. The glass melting furnace described in Patent Document 2 is provided with a clarifier tank, the inside of which is formed in a rectangular parallelepiped shape with a length, a width, and a depth at a specific ratio, in order to eliminate minute bubbles in melted glass.

In production of glass, a scale of a melting furnace has an influence on quality of glass. The larger the furnace is, the more easily high-quality glass is obtained. Accordingly, in a case of a small melting furnace, it is necessary to consider a structure capable of sufficiently eliminating bubbles from the melted glass, in order to obtain glass with the same quality as the case of large melting furnace. The arts disclosed in the aforementioned documents are to obtain high-quality glass by improving performance for eliminating bubbles in the melted glass.

However, in the glass melting furnaces disclosed in the aforementioned documents, it is difficult to sufficiently clarify glass and thus it is difficult to increase the production tact of glass. In order to sufficiently eliminate bubbles in the melted glass and supply high-quality glass, it is necessary to reform the apparatus to improve performance for eliminating bubbles in the melted glass that flows therein.

### DISCLOSURE OF THE INVENTION

The present invention is made in view of the aforementioned circumstances, and it is therefore an object of the invention to provide a glass melting apparatus capable of producing a small amount of high-quality glass (tens kilograms per day) adapted to be used to manufacture optical glass elements.

It is also an object of the invention to provide a glass manufacturing technique in which performance for eliminating bubbles in melted glass is improved so that high-quality glass to be optical glass elements can be obtained even if it is applied to a small size type glass melting furnace, and sufficient clarification can be performed even if the glass manufacturing tact is increased.

In order to achieve the above objects, according to one aspect of the invention, there is provided a glass melting apparatus, including: a clarifier tank, adapted to clarify melted glass which is obtained by melting a raw glass material; and partition walls, provided in the clarifier tank so as to define a meandering flow passage through which the melted glass flows, wherein: a bottom of the clarifier tank is sloped so that the flow passage ascends from an upstream side thereof to a downstream side thereof.

With this configuration, since the flow of the melted glass is accurately controlled and the melted glass flows at a depth corresponding to generation and growth of bubbles in the melted glass, it is possible to easily eliminate the grown bubbles. Accordingly, even when the configuration is applied to a small-sized glass melting apparatus, there can be attained continuously supply of glass which is efficiently clarified without containing non-melted glass material or bubbles. Since there is provided a small-sized glass melting apparatus with the improved performance for eliminating bubbles, it is possible to produce a small amount of high-quality glass for manufacturing optical elements or the like. Therefore, there is an advantage in productive efficiency and economical efficiency.

### BRIEF DESCRIPTION OF THE DRAWINGS

FIG. 1 is a horizontal section view of a glass melting apparatus according to a first embodiment of the invention, along a line b-b in FIG. 2.

FIG. 2 is a vertical section view of the glass melting apparatus, along a line a-a in FIG. 1.

FIG. 3 is a horizontal section view of a glass melting apparatus according to a second embodiment of the invention, along a line d-d in FIG. 4.

FIG. 4 is a vertical section view of the glass melting apparatus, along a line c-c in FIG. 3.

FIG. 5 is a vertical section view of a glass melting apparatus according to a third embodiment of the invention.

FIGS. 6A to 6D are vertical section views of a modified example of the glass melting apparatus of FIG. 1.

### BEST MODE FOR CARRYING OUT THE INVENTION

Glass is obtained by heating raw materials that contain glass constituents such as SiO₂ in a melting furnace. While the heated glass materials are formed into glass by reacting and melting, bubbles are generated due to impurities and dissolved gas. Accordingly, a process called as clarification for eliminating the bubbles from the melted glass is necessary. The bubbles generated in the melted glass floats by growth so as to be ejected from a surface of the melted glass or the bubbles are solved and absorbed in the melted glass so as to be shrunk or extinct. However, since any melted glass has high viscosity, a time is necessary until completing the eject and extinction of the bubbles.

Generally, a tank for clarifying melted glass has a rectangular shape in the plane view. In a large glass melting furnace, since a traveling distance of the melted glass is long, it is possible to ensure a sufficient clarifying time. However, in a small melting furnace, consideration to elongate a passage of the melted glass is necessary to ensure the sufficient clarifying time. When the melted glass slowly flows, turbulence or partial stay easily occurs in the flow. Accordingly, non-uniformity occurs in quality of the melted glass, or the floating of the bubbles is delayed at the part where the flow is partially stayed. Therefore, it is necessary to allow the melted glass to flow at a certain higher rate. For this reason, the clarifier tank needs to have a flow passage having a length capable of sufficiently eliminating the bubbles in the course of allowing the melted glass to flow at such a rate.

The inside of the clarifier tank is divided by partition walls to allow the melted glass to meander, so that the time period for which the melted glass flows in the clarifier tank with a constant volume at a prescribed rate is made equal to the time necessary for the clarification. For example, the space from an inlet to an outlet of the clarifier tank is divided using a plurality of partition plates in parallel, and thus it is possible to form a meandering flow passage. As a width of the flow passage is decreased and the number of meandering is increased, the flow passage becomes long.

In order to further improve the performance for eliminating bubbles in the clarifier tank, it is necessary to consider a generation circumstance of bubbles in the melted glass. The generation rate of the bubbles is not always constant but temporarily varies. Specifically, at the initial stage of the melted glass produced from glass materials, minute bubbles are actively generated. The generated bubbles are repeatedly united, grow largely, float in the melted glass, and finally reach the surface of the melted glass and collapse, and then generated gas is ejected in the air. In consideration of the above process, in order to easily grow the bubbles of the melted glass at the initial stage of clarification and to easily eject the bubbles from the melted glass at the last stage of the clarification, the clarifier tank may be appropriately configured to decrease the depth of the melted glass as the melted glass proceeds in the passage. Specifically, when the bottom surface of the clarifier tank is formed to be sloped so that the flow passage of the melted glass ascends from the inlet side (upstream side) to the outlet side (downstream side), the depth of the melted glass becomes shallow as the melted glass proceeds, thereby coping with the growth process of the bubbles. According to such a configuration of the flow passage, the elimination efficiency of the bubbles is improved. The slope may be continuous or stepwise according to the shape of the bottom surface of the clarifier tank.

In addition, the structure of the flow passage rising from the upstream side to the downstream side has an advantage in accurately controlling the flow of the melted glass. Specifically, in order that the melted glass proceeds in the flow passage rising by the slope of the bottom surface of the clarifier tank, it is necessary to raise the surface of the melted glass corresponding to the level of the bottom surface. That is, the melted glass does not proceed as long as the surface of the melted glass does not rise by supplying the glass materials. The melted glass proceeds in the forwarding direction of the flow passage according to the supply of the glass materials. In other words, the supply of the glass materials acts as pressure that pushes the melted glass into the flow passage. The proceeding rate of the melted glass can be accurately adjusted by controlling the supplying rate of the glass materials.

The flow rate of the melted glass can be adjusted on the basis of a cross section perpendicular to the proceeding direction (direction in which the melted glass flows) of the flow passage divided by the partition walls. Specifically, as the width of the flow passage becomes smaller, the cross section thereof becomes smaller and thus the flow rate of the melted glass becomes higher. Accordingly, in the structure in which the flow passage ascends from the upstream side to the downstream side, when the width of the flow passage is constant, the cross section of the melted glass decreases and thus the flow rate of the melted glass is increased. In order to regulate the flow rate of the melted glass, the width of the flow passage may be enlarged from the upstream side to the downstream side in order to make the cross section constant.

The clarifier tank described above may be set in consideration of settings such as the production tact of glass, so as to have the length of the flow passage in which the melted glass flows for 2 hours or more in the clarifier tank.

In order to perfectly regulate the flow of the melted glass by the partition walls, the partition walls are set higher than the surface of the melted glass. However, the partition walls may obstruct eliminating bubbles in the melted glass. When the bubbles of the melted glass float from the melted glass and reach the surface of the melted glass, the bubbles collapse. However, when there are partition walls, the bubbles coming into contact with the partition walls do not easily collapse and the bubbles easily gather in the vicinity of the interface between the surface of the melted glass and the surface of the partition walls. For this reason, even when the bubbles generated in vicinity of the partition walls remain by coming in contact with the partition walls or grow to float along the partition walls, the bubbles do not collapse and tend to gather and flow to the downstream side. Therefore, it is difficult to raise the flow rate and production tact of the melted glass.

In order to solve this problem, there is a method in which a part of the partition walls is configured to be lower than the surface of the melted glass. In such a case, when the bubbles occurring in the vicinity of the partition wall and coming into contact with the partition wall are grown, buoyancy of the bubbles becomes higher and the bubbles easily separate from the top of the partition wall. Accordingly, the bubbles reach the surface of the melted glass and easily collapse so that it is possible to prevent the bubbles from staying on the surface of the partition walls or from flowing to the downstream side along the partition walls, thereby improving the performance for eliminating bubbles.

In order to improve the performance for eliminating bubbles as described above, a difference between the top of the partition wall and the surface of the melted glass may be equal to or larger than the size of the bubbles. Since the size of the bubbles in the melted glass is at most several millimeters, the difference between the top of the partition wall and the surface of the melted glass is 1 mm or more, and preferably 3 mm or more. At the portion where the partition wall is lower than the surface of the melted glass, the melted glass is allowed to go over the partition wall and deviate from the upstream side to the downstream side. In order to prevent this, the difference of the top of the partition wall and the surface of the melted glass is about 40 mm or less, and preferably about 9 mm or less. In addition, it is preferable that the portion where the partition wall is lower than the surface of the melted glass is disposed so as not to continue along a direction from the inlet to the outlet. Particularly, in portions where the flow of the melted glass is changed (the flow passage is curved), it is preferable that the portion where the partition wall is lower than the surface of the melted glass does not continue in the direction from the inlet to outlet.

The partition walls defining the flow passage may be configured using plural kinds of partition plates with a constant height or using partition plates each having a high portion and a low portion. In order to improve the performance for eliminating bubbles, a percentage of the portion where the partition wall is lower than the surface of the melted glass in the total partition walls is preferably about 10% or more. In order to prevent interfusion contamination into the downstream melted glass caused by the deviation of the melted glass by appropriately controlling the flow of the melted glass, a percentage of the portion where partition wall is lower than the surface of the melted glass is preferably about 50% or less. In other words, the percentage of the portion higher than the surface of the melted glass is preferably in the range of 50 to 90% among all the partition walls. When partition plates higher than the surface of the melted glass and the partition plates lower than the surface of the melted glass are combined, it is easy to change a design according to situation.

In such a manner, it is reduced the possibility that the bubbles remain in the vicinity of the partition walls to promote the elimination of the bubbles. Accordingly, even when the flow passage of the melted glass is not extremely elongated, it is possible to increase the efficiency for eliminating bubbles in the clarifier tank. When the partition walls lower than the surface of the melted glass are used, there is a problem of the deviation or the interfusion of the melted glass into the down stream side. However, this is compensated by combination with the structure in which the flow passage ascends toward the downstream side, and the melted glass is efficiently prevented from going over the partition walls and deviating.

As the other method for improving the performance for eliminating bubbles, minute unevenness may be provided in a part of the partition walls to promote the growth of the bubbles. This unevenness is formed at the lower side than the surface of the melted glass, and preferably at the middle of the lower portion of the partition walls in the melted glass. When the unevenness is provided in the vicinity of the surface of the melted glass, the bubbles are collected on the surface of the wall and flows into the downstream side, which is not preferable. In order to efficiently eliminate bubbles in the melted the melted glass, the unevenness of the partition walls is provided most preferably in the area of the upstream side of the flow passage of the melted glass. When the unevenness is provided on the partition walls in the portion lower than the surface of the melted glass, the growth of the bubbles is allowed to be promoted so that the grown bubbles easily float from the top of the partition wall. Accordingly, this unevenness is preferable as means for promoting the elimination of bubbles. Even when the minute unevenness is provided on the lower portion of the upstream area of the flow passage, the same effect can be obtained.

When minute through holes passing through the partition walls are provided instead of the minute unevenness, the bubbles in the melted glass is captured in the through holes to promote the collection growth and thus the bubbles easily floats. That is, the flow of the melted glass allows the bubbles to be positively collected in the opening portions of the through holes when the melted glass passes through the through holes. Accordingly, the bubbles are captured on the surface of the partition wall and grows, thereby increasing the effect of improving the performance for eliminating bubbles. A diameter of the through hole is preferably about 3 mm, because most of bubbles are larger than the through holes and the bubbles are captured in the opening portion. The diameter thereof is more preferably about 1 mm or less. The bubbles entering the through hole is also captured by the contact with the inner wall of the hole. The through holes may be used with the minute unevenness.

When the aforementioned unevenness or the through holes are provided in a portion where fluid pressure of the melted glass against the partition wall is high, that is, an area where the flow of the melted glass is perpendicular to the surface of the partition wall or gets close thereto, it is possible to more aggressively grow and capture the bubbles. Specifically, when the unevenness or the through holes are provided on the partition wall in the portion defining the area where the flowing direction of the melted glass is changed in the flow passage of the melted glass or on the side wall of the clarifier tank, it is easy to grow and capture the bubbles. When the growth of the bubbles are promoted in the initial melted glass in which the bubbles are easily generated, there is an advantage in the improvement of the performance for eliminating bubbles. Accordingly, it is effective that the unevenness or the through holes are provided on the partition wall provided at the portion facing the flow of the melted glass in the initial stage of the melting.

As means for promoting the growth of the bubbles, a member having minute unevenness or through holes may be further provided on the upstream side of the flow passage so as to be disposed in the area lower than the surface of the glass melted glass, other than the aforementioned unevenness or the through holes provided on the partition wall.

Hereinafter, the glass melting apparatus according to embodiments of the invention will be described in detail.

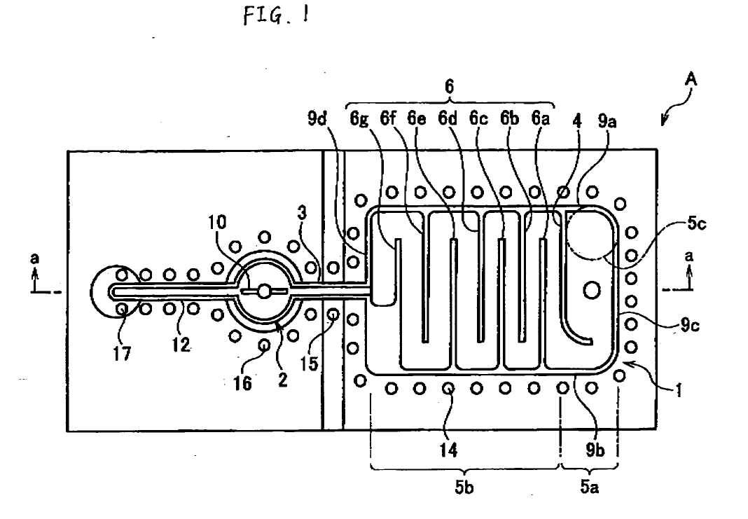

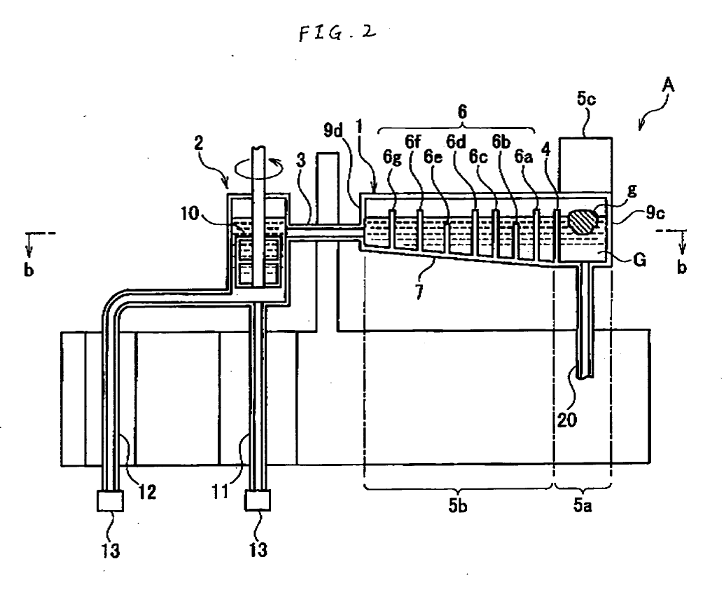

FIGS. 1 and 2 illustrate a glass melting apparatus according to a first embodiment of the invention, in which a part of the partition walls defining the flow passage of the melted glass is configured to be lower than the surface of the melted glass.

The glass melting apparatus A includes a melter/clarifier tank 1 and a homogenizer tank 2. The melter/clarifier tank 1 and the homogenizer tank 2 are connected to each other through a connection pipe 3. The melter/clarifier tank 1 has right and left side walls 9a and 9b, an upstream side wall 9c, and a downstream side wall 9d that define a horizontal section to be a substantially rectangular shape. The melter/clarifier tank 1 is divided into an entrance section 5a for introducing raw glass to heat and melted glass the raw glass and a clarifying section 5b for clarifying the melted glass, by an entrance partition plate 4 extended in a vertical direction. A glass material (cullet) g is introduced from a cylindrical introduction pipe 5c to the entrance section 5a of the melter/clarifier tank 1. The inside of the clarifying section 5b is divided by vertically-extended partition walls 6 to form a flow passage of a melted glass G. When the glass material g in the entrance section 5a is melted by heating to form the melted glass G, the melted glass G flows in the clarifying section 5b and proceeds into the flow passage divided by the partition walls 6 and then the melted glass G is introduced into the homogenizer tank 2 through the connection pipe 3. The homogenizer tank 2 is provided with a stirring propeller 10 therein, the melted glass G introduced from the melter/clarifier tank 1 through the connection pipe 3 is stirred and sufficiently homogenized. The homogenizer tank 2 is provided with ejection nozzles 11 and 12, and the melted glass G in the homogenizer tank 2 is controlled to be a temperature suitable for forming FG (fine gob) and then is ejected.

In the embodiment, the entrance section 5a and the clarifying section 5b are integrated into the melter/clarifier tank 1, but the entrance section 5a may be separated from the clarifying section 5b to supply the melted glass melted in an entrance tank through the connection pipe to a clarifier tank.

In order to heat each of the portions of the glass melting apparatus A, a plurality of heaters 13, 14, 15, 16, and 17 (not shown in FIG. 2) are provided, and heating temperatures are appropriately controlled to be suitable for the portions, respectively. Specifically, the heater 14 is controlled so that there is no non-melted glass material g in the melter/clarifier tank 1 and the temperature thereof becomes a temperature suitable for clarification. The heater 15 is controlled to be a temperature suitable for eliminating minute dust bubbles included in the melted glass in the connection pipe 3. The heater 16 is controlled to be a temperature suitable for stirring in the homogenizer tank. The heaters 13 and 17 are controlled so that the melted glass ejected from the homogenizer tank 2 is to be a temperature in an appropriate outflow state obtained as the FG in the following process. In the vicinity of the heaters 14, 15, 16, and 17, a heat insulator (not shown) is disposed to cover the whole glass melting apparatus A, thereby keeping the temperatures of the portions of the glass melting apparatus A. At least surfaces of all the melter/clarifier tank 1, the homogenizer tank 2, the connection pipe 3, the entrance partition plate 4, the partition walls 6, the nozzles 11 and 12, and the stirring propeller 10 are made of platinum or platinum alloy. The entrance section 5a of the melter/clarifier tank 1 is provided with a drain pipe 20, and generally the glass flows without heating. However, when there is a need for ejecting the glass in the melter/clarifier tank 1, the drain pipe 20 may be heated. A bottom 7 of the melter/clarifier tank 1 is sloped and thus the glass can be completely ejected through the drain pipe 20.

As shown in FIG. 2, the partition walls 6 includes partition plates higher than the surface of the melted glass G and partition plates lower than the surface of the melted glass G. Tops of the entrance partition plate 4 and the partition plates 6a, 6c, 6d, 6f, and 6g are located higher than the surface of the melted glass G, and tops of the partition plates 6b and 6e are located lower than the surface of the melted glass G. Bottoms of the entrance partition plate 4 and the partition plates 6a to 6g are fixed to the bottom 7 of the melter/clarifier tank 1. The entrance partition plate 4 and the partition plates 6a to 6g are parallel to the upstream side wall 9c and the downstream side wall 9d. One side end thereof is perpendicularly fixed to the side wall 9a or 9b of the melter/clarifier tank 1, and the other side end is away from the side wall 9a or 9b. Portions where the partition plates 6a to 6g are away from the side wall 9a or 9b are provided alternately on the right and left sides from the upstream side to the downstream side, thereby the flow passage of the melted glass G is defined in meandering shape. Accordingly, the melted glass G flowing in the flow passage meanders right and left. The free ends of the entrance partition plate 4 are curved toward the entrance section 5a. In the embodiment, since the outlet connected to the connection pipe 3 is provided at the middle of the downstream side wall 9d, the flow passage located at the more downstream side than the outlet is closed to prevent the melted glass G from being precipitated on the utmost downstream side of the flow passage. However, the location of the outlet may be provided at a corner portion of a side diagonal to the introduction pipe 5c to eject the melted glass G from the utmost downstream side of the flow passage.

The bottom 7 of the clarifying section 5b is a plane that is gradually sloped from the upstream side to the downstream side. In the embodiment, since the entrance partition plate 4 and the partition plates 6a to 6g are disposed parallel to the upstream side wall 9c and the downstream side wall 9d of the melter/clarifier tank 1 and the level of the flow passage substantially stepwise ascends from the upstream side to the downstream side, the melted glass G is prevented from deviating and interfusing into the downstream side particularly in the vicinity of the side walls 9a and 9b by gravity. A depth of the melted glass G substantially stepwise decreases from the upstream side to the downstream side. Meanwhile, a width of the flow passage, that is, a distance between the entrance partition plate 4 and the partition plates 6a to 6g stepwise increases from the upstream side to the downstream side, sectional areas perpendicular to the flowing direction of the melted glass G are substantially equal to each other from the upstream side to the downstream side. Accordingly, when the glass material g is supplied to the entrance section 5a at a prescribed rate to generate the melted glass G at a prescribed rate, the melted glass G flows from the upstream side to the downstream side in the flow passage substantially at the same rate. On the other hand, since the depth of the melted glass G is stepwise decreases, in the upstream side, the minute bubbles generated in the initial melted glass G ascends while the bubbles grows to such a size that the bubbles easily break. In the downstream side, since the melted glass G is shallow, it is easy to eliminate bubbles in the melted the melted glass G. The bubbles growing and coming into contact with the partition walls 6b and 6e easily float from the upper portion of the partition wall located lower than the surface of the melted glass G.

In the embodiment shown in FIGS. 1 and 2, the slope of the bottom 7 of the clarifying section 5b may be configured so that the depth of the melted glass gradually decreases even in each step of the meandering flow passage (the bottom continuously ascends). In this case, the bottom 7 is not configured in a plane shape but is configured in a meandering switchback shape. In the embodiment shown in FIGS. 1 and 2, the flow passage constantly ascends, but the bottom 7 may be formed of a curved plane to change the gradient according to positions.

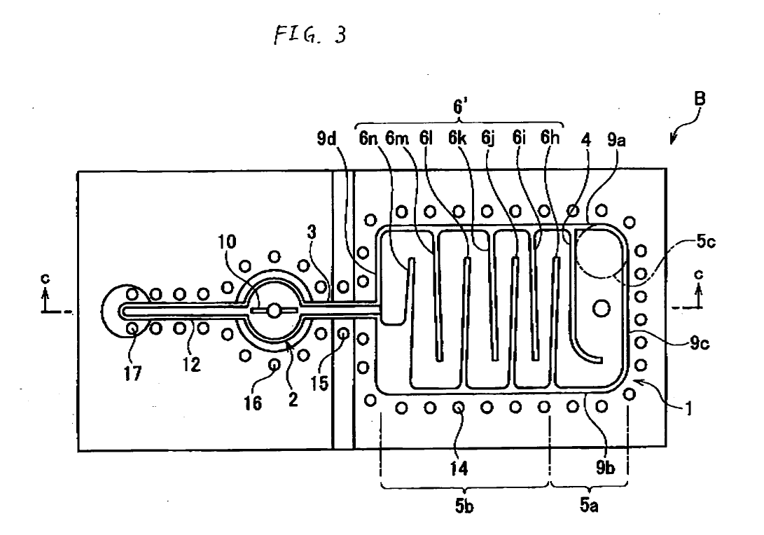

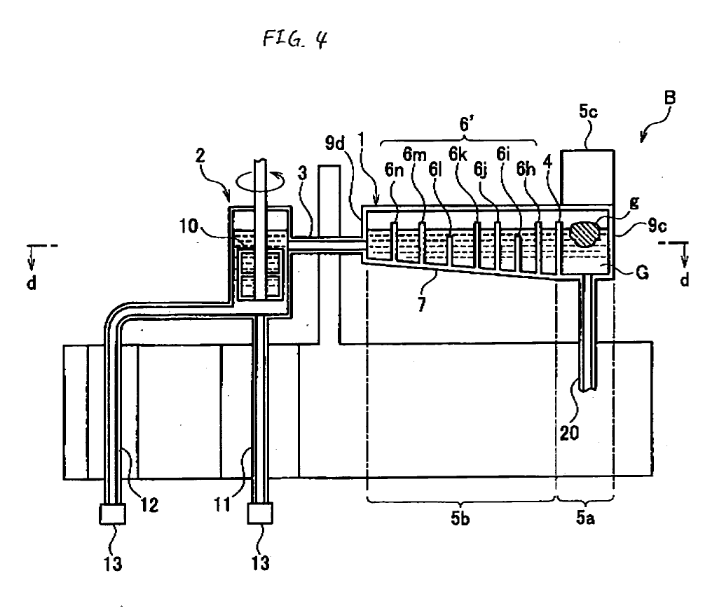

FIGS. 3 and 4 illustrate a glass melting apparatus according to a second embodiment of the invention. The glass melting apparatus B is different from the first embodiment in that partition plates 6h to 6n constituting partition walls 6′ defining the flow passage of the melted glass are extended toward the upstream side from perpendicularity to the side walls 9a and 9b. For this reason, the width of the flow passage stepwise increases over all, but the width gradually decreases in each step from the upstream side to the downstream side. Accordingly, the flow rate of the melted glass G increases while the melted glass G straight flows and then the flow rate decreases while the melted glass is curved, which is repeated to flow from the upstream side to the downstream side. As a result, when the straight flowing melted glass G encounters the side walls 9a and 9b, the fluid pressure thereof increases. Therefore, it is difficult that precipitation of the flow occurs in the vicinity thereof.

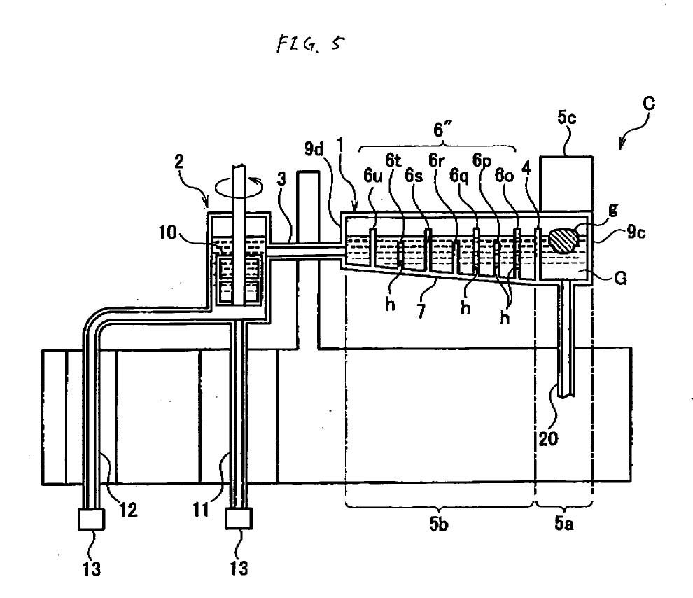

FIG. 5 illustrates a glass melting apparatus according to a third embodiment of the invention. In the glass melting apparatus C, the size and the disposition of partition plates 6o to 6u constituting partition walls 6″ defining the flow passage of the melted glass are the same as the partition plates 6a to 6g of the first embodiment shown in FIGS. 1 and 2, but are different in that the partition plates 6o, 6p, 6q, and 6t are provided with minute through holes h. The through holes h have a function of growing and capturing the bubbles, the through holes h mainly promote the growth of the bubbles in the initial melted glass G in the upstream partition plates 6o, 6p, and 6q, and the through holes mainly promote the capturing and floating of the bubbles in the partition plate 6t from the midstream side to the downstream side. The through holes of the partition plates 6o, 6p, and 6q may be replaced as minute unevenness. In addition, the minute unevenness or the through holes may be provided at portions where the melted glass flowing out from the entrance section 5a encounters the partition plates 6a, 6h, and 6o, or may be provided on the side walls 9a and 9b of the embodiment shown in FIGS. 3 and 4. The minute unevenness or the through holes are good in promoting the growth of the bubbles in the portions that the melted glass encounters. The height and depth of the unevenness are preferably 3 mm or less, and more preferably 1 mm or less. The diameter of the through holes is preferably 5 mm or less, and more preferably 1 mm or less.

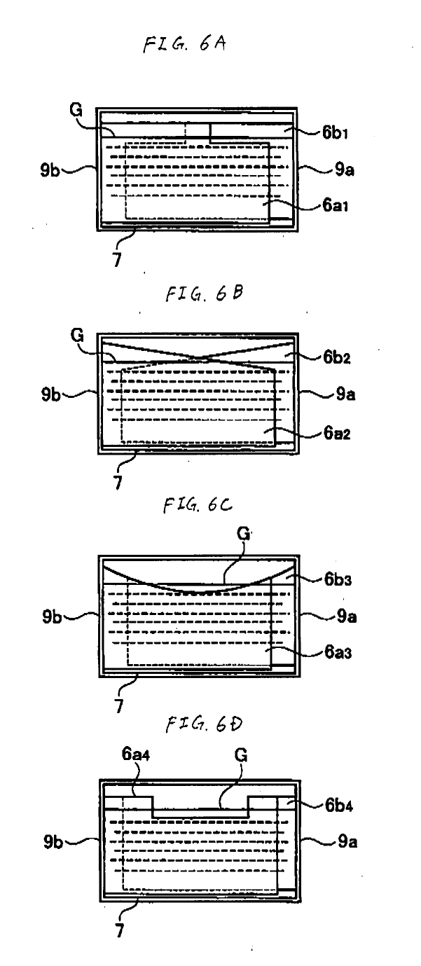

Each of the partition plates in the aforementioned embodiment has a constant height. However, FIGS. 6A to 6D illustrate four examples in which the partition plates 6a to 6g of the glass melting apparatus A shown in FIGS. 1 and 2 are modified into partition plates having a higher portion than and a lower portion than the surface of the melted glass. FIGS. 6A to 6D are diagrams illustrating the vertical section according to the entrance partition plate 4 of the melter/clarifier tank 1 as viewed from the upstream side to the downstream side. Partition plates 6a1 to 6a4 are used instead of the partition plate 6a, partition plates 6b1 to 6b4 are used instead of the partition plate 6b, and partition plates 6c to 6g are changed to the same forms as the partition plates 6a1 to 6a4 and 6b1 to 6b4. FIGS. 6A and 6B are examples configured so that the partition plates are higher than the surface of the melted glass on the upstream side and are lower than the surface of the melted glass on the downstream side. FIGS. 6C and 6D are examples configured so that the partition plates are higher than the surface of the melted glass on the upstream and downstream sides and are lower than the surface of the melted glass on the midstream area. In the examples shown in FIGS. 6C and 6D, the portions lower than the surface of the melted glass continue from the entrance section 5a to the outlet, but the melted glass G straight flows the portions and it is relatively difficult that precipitation or deviation of the flow occurs. The shapes of the partition plates shown in FIGS. 6A to 6D may be combined. For example, the partition plate shown in FIGS. 6C and 6D may be used on the upstream side, and the partition plate shown in FIG. 6A or 6B may be used on the downstream side.

Hereinafter, there will be described an example of a working process for preparing melted glass to be molded as FG using the glass melting apparatus A shown in FIGS. 1 and 2.

Mixed powder obtained by appropriately blending various kinds of industrial materials (SiO₂, BaCo₃, Ba(NO₃)₂, H₃BO₃, Al(OH)₃, Li₂CO₃, Na₂CO₃, K₂CO₃, and ZnO) is melted in a platinum crucible at a temperature of 1250° C. for several hours, so that component composition of the melted glass is substantially SiO₂: 41 mass % (hereinafter, referring to mass % as %), BaO:27%, B₂O₃: 14%, Al₂O₃: 5%, Li₂O+Na₂O+K₂O: 9%, ZnO: 4%, and a small amount of the others, so as to be formed into glass. Then, the glass is stirred, is allowed to flow in water, and then is dried, thereby obtaining coarse cullet. In this case, two kinds of cullet with high refractive index and low refractive index are prepared by controlling the combination composition, and the two kinds of cullet are mixed to obtain a desired refractive index. The obtained mixture is used as a glass material for the following works.

The melter/clarifier tank 1 was configured by a substantially rectangular shape (when the minimum depth of the melted glass G is 60 mm, a capacitance of the clarifying section 5b for the melted glass is about 8000 cc) with a length of 410 mm, a width of 250 mm, and a height of 100 mm. Since the entrance section 5a is integrated with the clarifying section 5 as shown in FIG. 1, and the cylindrical introduction pipe 5c for introducing the cullet g is located at the upper portion of the entrance section 5a. The homogenizer tank 2 is formed in a cylindrical shape and is configured so that a capacitance thereof is 1000 cc in a state where the stirring propeller 10 is inserted therein. An inner diameter of the nozzles 11 and 12 is set to 8 mm.

In the glass melting apparatus A, the heaters 13, 14, 15, 16, and 17 are individually controlled so that a temperature of the entrance section 5a and the clarifying section 5b is 1250° C., a temperature of the connection pipe 3 is 1100° C., a temperature of the homogenizer tank 2 is 1050° C., and a temperature of the ejection nozzles 11 and 12 is 1050° C. at the outlet. When the cullet g of the glass material is supplied to the introduction pipe 19, the cullet g is melted for several minutes and flows into the clarifying section 5b through the curved portion of the entrance partition plate 4. The melted glass G passes through the melter/clarifier tank 1 with 1250° C. for about 2 hours, thereby sufficiently clarifying the melted glass G to flow into the connection pipe 3. A little minute dust bubbles disappears, and the melted glass G flows out from the connection pipe 3. Thus, the melted glass having no non-melted glass material and no interfusion of bubbles are accommodated in the homogenizer tank 2. In the homogenizer tank 2, the melted glass is stirred by the stirring propeller 10 while the temperature of the melted glass decreases. The homogenized melted glass gradually flows out through the ejection nozzles 11 and 12. The flow rate of the melted glass obtained from the nozzles 11 and 12 is about 600 cc/hour in total. Accordingly, it is possible to obtain a high-quality FG sufficiently usable as molding materials for optical elements without interfusion such as non-melted glass material, bubbles, striae, or the like.

The FG, which is prepared by the glass melting apparatus A and is to be molded, is usable as molding materials of optical elements used for cameras, video cameras, digital cameras, and the like.

### INDUSTRIAL APPLICABILITY

The invention is applicable as a small-sized glass melting apparatus capable of providing a high-quality fine gob suitable for a precise press-molding work. The glass materials produced by the glass melting apparatus according to the invention are high-quality molding materials for optical elements which are able to be utilized as various optical elements without polishing after the press-molding is performed. Therefore, the invention improves a mass producing property of the optical elements and thus is applicable as a technique for providing an economical producing method.

1. A glass melting apparatus, comprising:
a clarifier tank, adapted to clarify melted glass which is obtained by melting a raw glass material; and
partition walls, provided in the clarifier tank so as to define a meandering flow passage through which the melted glass flows, wherein:
a bottom of the clarifier tank is sloped so that the flow passage ascends from an upstream side thereof to a downstream side thereof.

2. The glass melting apparatus as set forth in claim 1, wherein:
the partition walls includes a portion to be higher than the surface of the melted glass and a portion to be lower than the surface of the melted glass.

3. The glass melting apparatus as set forth in claim 1, wherein:
the partition walls have uneven surfaces.

4. The glass melting apparatus as set forth in claim 1, wherein:
the partition walls are provided with through holes.
